(19) United States
(12) Patent Application Publication
(10) Pub. No.: US 2011/0053659 A1
(43) Pub. Date: Mar. 3, 2011

(54) Integral mobile device storage compartment

(76) Inventor: Gregory Michael Murphy, Midlothian, VA (US)

(21) Appl. No.: 12/584,146

(22) Filed: Sep. 1, 2009

(51) Int. Cl. H04M 1/00

(52) U.S. Cl. 455/575.1

(57) ABSTRACT

A storage device for mobile devices is disclosed herein. The mobile device may integrally attach to the mobile device and may include a battery cover panel, a back panel, and a plurality of side panels, each protruding from the battery cover panel to the back panel, the various panels forming a storage cavity therein. The storage device may attach to the mobile device using battery panel attachment mechanisms typically utilized by mobile devices for attaching battery covers. The storage device may further include a door for accessing the storage compartment.

### BACKGROUND OF THE INVENTION

In general, the present invention is directed towards a storage compartment that is attachable to a mobile device. Specifically, the storage compartment is formed using a panel or portion of the body or casing of the mobile device itself, thereby making the storage compartment integral to the mobile device.

The use of mobile telephone handsets and mobile devices are pervasive and widespread, with users ranging from nearly every age group and every walk of life. For most, having a mobile handset is a near necessity, due to the need for constant communication. As mobile handsets evolve into smart-phones—devices capable of performing not only telecommunication services but internet browsing, and running numerous applications—the apparent necessity for having a handset with a user has increased.

Mobile devices have added to the numerous items that a typical person must carry throughout their day. Numerous apparatuses exist that attach such handsets to a user's belt, purse, or other area are well-known. Cases to protect and keep mobile devices accessible are common place. Some cases may include an additional pocket for storage.

As mobile devices become more of a necessity, there is a need to reduce the amount of items that are carried by various users. For example, there are times when a user may wish to carry a mobile device, a bit of money and a key, such as when walking a pet. Another example may be when a person wishes to use a gym and would like to carry a mobile device and an identifying card or information. Yet another example may be when a business person attends a conference or meeting and wishes to carry a mobile device and numerous business cards for distribution. In

However, existing cases that provide additional storage are typically bulky and fabric, and fail to protect any items stored therein. Moreover, in addition to their utility, mobile devices make a fashion statement about the user. The use of bulky cases with additional storage pockets is awkward and typically undesirable.

Accordingly, there is a need for a type of storage compartment that can be used to store items often contained in a wallet—for example, cash, credit cards, business cards, etc.—that can be cleanly attached to the mobile device without destroying the utility or style of the device.

### SUMMARY OF THE INVENTION

Aspects of the present invention include a storage device for mobile devices. The mobile device may integrally attach to the mobile device and may include a battery cover panel, a back panel, and a plurality of side panels, each protruding from the battery cover panel to the back panel, the various panels forming a storage cavity therein. The storage device may attach to the mobile device using battery panel attachment mechanisms typically utilized by mobile devices for attaching battery covers. The storage device may further include a door for accessing the storage compartment.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 depicts a mobile device as is commonly used in the prior art, without any additional storage compartments or cases.

FIG. 2 depicts an exploded view of the back of a mobile device and its battery compartment as is commonly used in the prior art, without any additional storage compartments or cases.

FIG. 3 illustrates a storage compartment in accordance with some embodiments of the present invention.

FIG. 4 illustrates an exploded view of the back of a mobile device equipped with a storage compartment in accordance with some embodiments of the present invention.

FIG. 5 illustrates isometric view of a mobile device equipped with a storage compartment in accordance with some embodiments of the present invention.

FIG. 6 illustrates a side view of a mobile device equipped with a storage compartment in accordance with some embodiments of the present invention.

FIG. 7 illustrates a mobile device equipped with a storage compartment in the open position, in accordance with some embodiments of the present invention.

FIG. 8A-8D illustrates various opening arrangements of a storage compartment in accordance with some embodiments of the present invention.

FIG. 9 depicts an exemplary latching mechanism for a storage compartment in accordance with some embodiments of the present invention.

### DETAILED DESCRIPTION

Reference will now be made in detail to embodiments of the invention, examples of which are illustrated in the accompanying drawings.

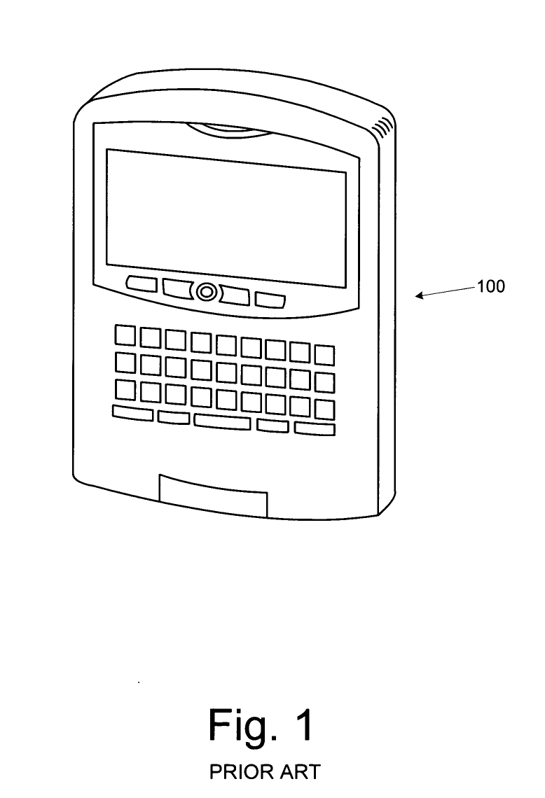

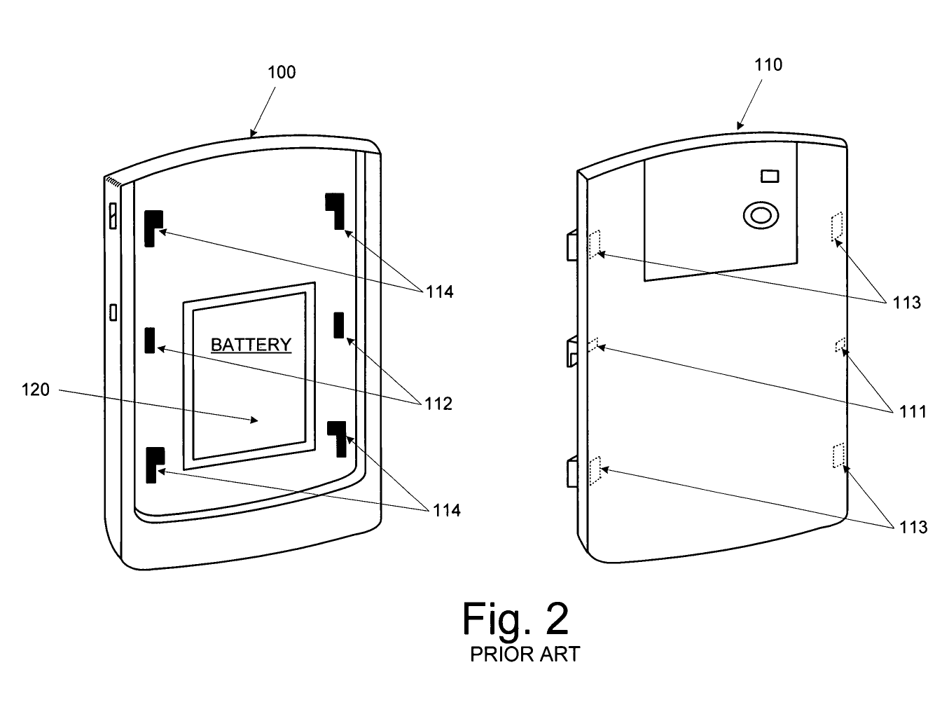

FIG. 1 depicts a popular mobile device 100, for example the Blackberry Curve™, sold by Research In Motion. It is evident that a case into which such a mobile device would fit and provide additional storage would be bulky and unattractive. FIG. 2 illustrates the back of the mobile device 100, showing the rear battery door 110 and the rear batter compartment 120. The battery door 110 is attached to the mobile device 100 via the “L” shaped hooks 111, which engage in slots 112 on the mobile device, as well as alignment mechanisms 113 which engage in slots 114 on the mobile device.

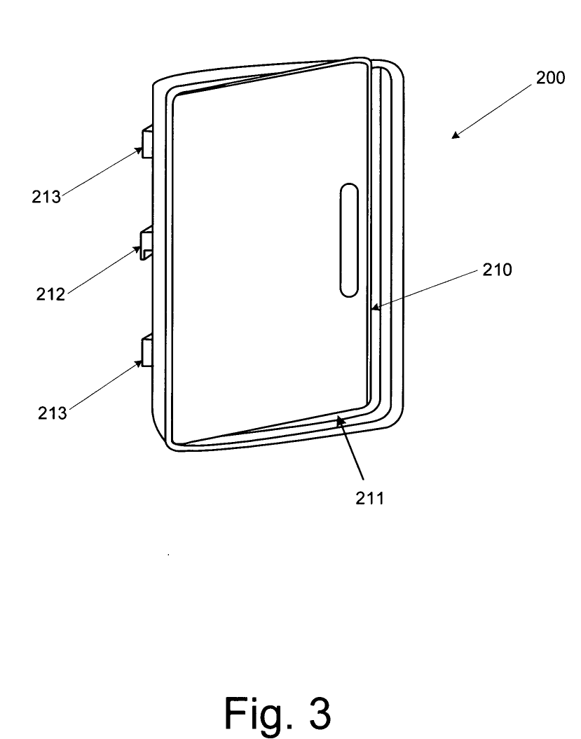

FIG. 3 illustrates a storage compartment 200 in an open position, in accordance with some embodiments of the present invention. The storage compartment 200 includes a cavity 210 for storing various items, such as identification or credit cards, cash, business cards, an additional device battery, or any such item. While the storage compartment 200 is illustrated with a width approximately less than the width of the mobile device 100, this is exemplary only and the storage compartment 200 may be any desirable width.

With continued reference to FIG. 3, the storage compartment 200 contains a panel section 211 that is similar to the battery door 110 of the mobile device 100. Moreover, the panel section 211 comprises attachment mechanisms similar to the battery door 110. For example, FIG. 3 depicts the storage compartment 200 having “L” shaped hooks 212 and alignment mechanisms 213 for attaching to the mobile device 100.

Note that while “L” shaped hooks are discussed, this is exemplary only. The attachment mechanisms for battery doors for various mobile devices differ widely, and the specific storage compartment 200 designed for each such mobile device may have identical or similar attachment mechanisms.

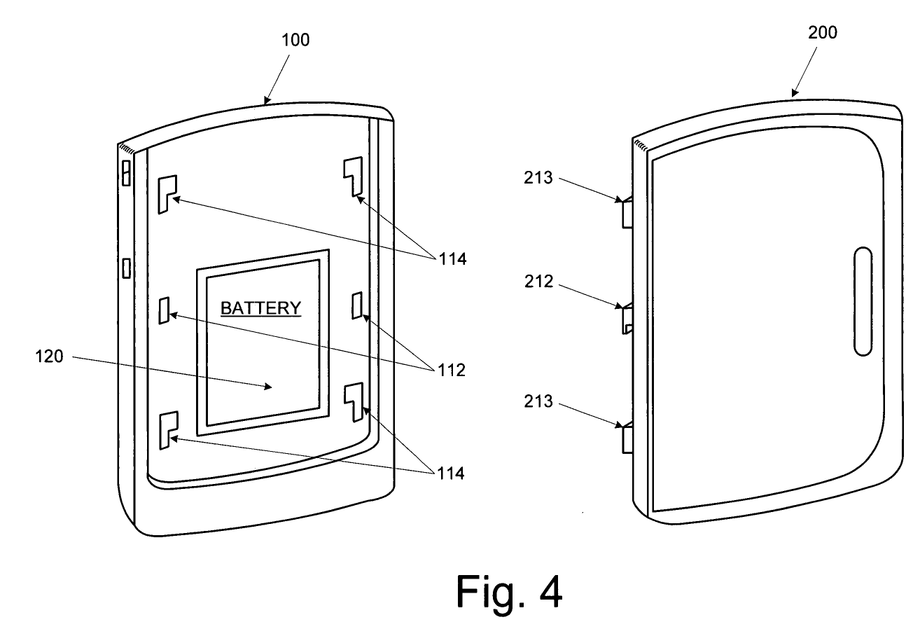

FIG. 4 depicts an exploded view of a mobile device with a storage compartment, rather than the standard battery door, in accordance with some embodiments of the present invention. With reference to FIG. 4, it is apparent that the storage compartment 200 is attached to the mobile device 100 using “L” shaped hooks 212 and alignment mechanisms 213 inserted into the slots 112 and 114 in the mobile device intended for the battery door 110. In this manner, the storage compartment 200 may be integral to the mobile device 100. In other words, the rear surface of the storage compartment replaces the back panel of the mobile device 100, thereby making the mobile device 100 and the storage compartment 200 connected.

In this manner, a more aesthetic, sleek, and solid connection can be achieved. In addition, the storage compartment 200 dimensions and shapes can be tailored so that the mobile device can be used in various pre-existing clips, docking stations, and/or mounting devices.

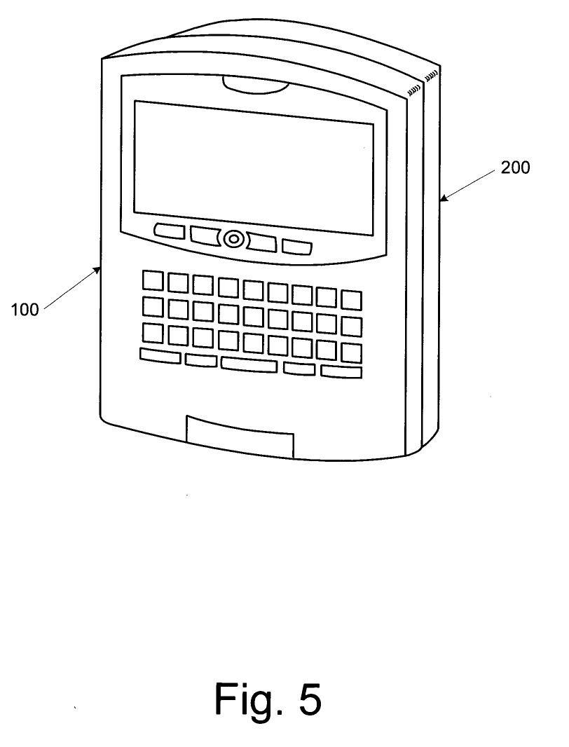

FIG. 5 illustrates a mobile device 100 with a storage compartment 200 attached, in accordance with some embodiments of the invention. It can be seen that there is no, or a negligible sized, gap between the storage compartment 200 and the mobile device 100. Rather, the storage compartment 200 appears to be an originally designed part of the mobile device 100.

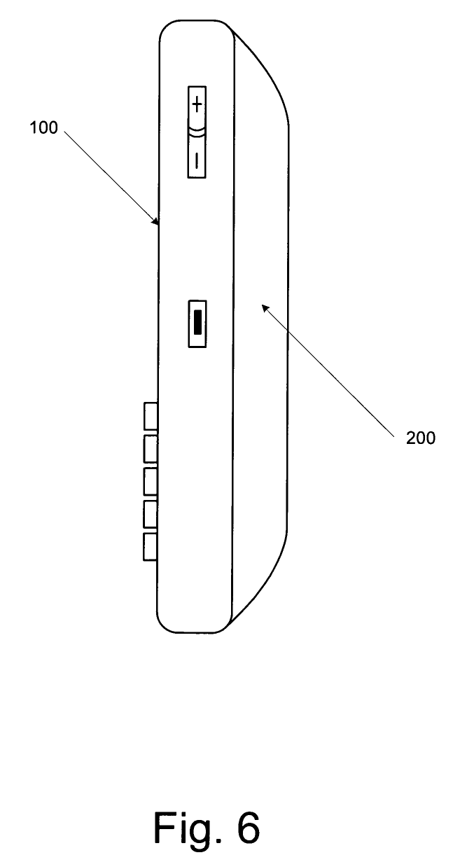

FIG. 6 depicts a side view of a mobile device 100 with a storage compartment 200 attached, in accordance with some embodiments of the present invention. As noted earlier, the width of the storage compartment 200 can vary, depending on the intended use and model selected. For example, a sleek and thin storage compartment 200 may be used when the intended purpose is to hold an identification card, credit card, and a bit of cash—for example when used in lieu of a purse or wallet by a female. Alternatively, the storage compartment 200 may be much thicker when the intended purpose is to hold an extra mobile device battery and numerous business cards—for example when used by a traveling business person.

The types of compartments that may be attached to and used with mobile devices are numerous. For example, such compartments can be configured to hold toiletries, such as makeup (e.g., lipstick, rouge, etc), feminine necessities, cologne or perfume, gum or mints, birth control (e.g., pills, condoms, ITUs, etc.), medicine or pharmaceuticals, EpiPen™, blood sugar testing devices or strips, contacts or saline, keys, jewelry, cigarettes or other smoking accessories, photos, thumb drives or other digital media storage devices, identification badges for secured access. Several of these items may require specific storage compartment characteristics, such as being leak-proof, water proof, or preventing demagnetization of various cards or devices.

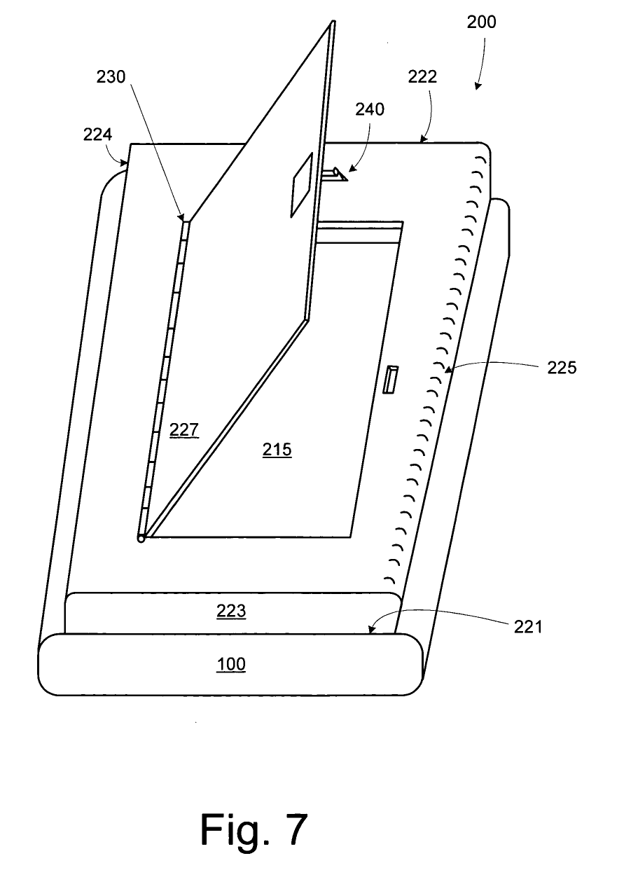

FIG. 7 illustrates a mobile device 100 equipped with a storage device 200 in an open position, in accordance with some embodiments of the present invention. Note that the particular opening arrangement is exemplary only, and various opening arrangements may be used, all of which are anticipated by the present invention.

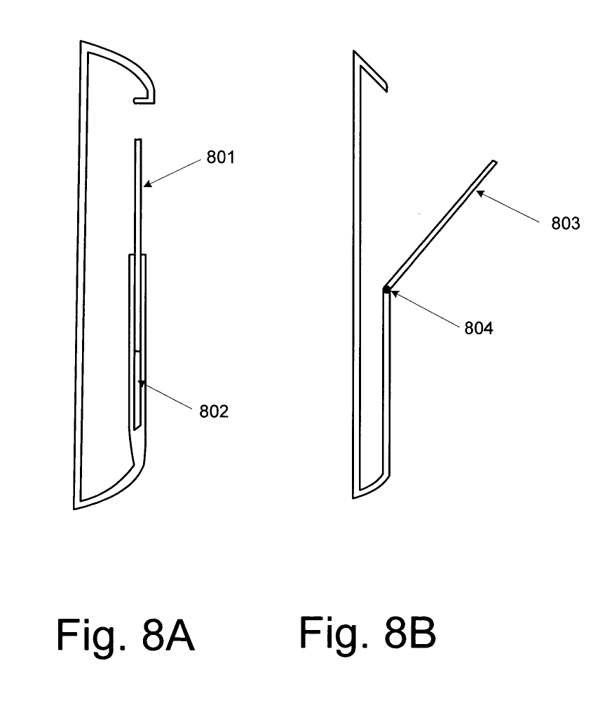

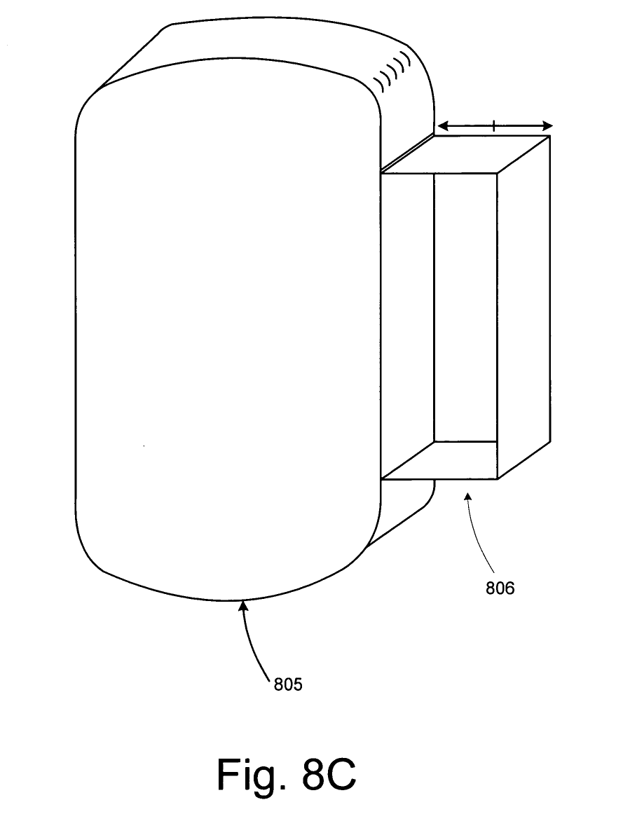

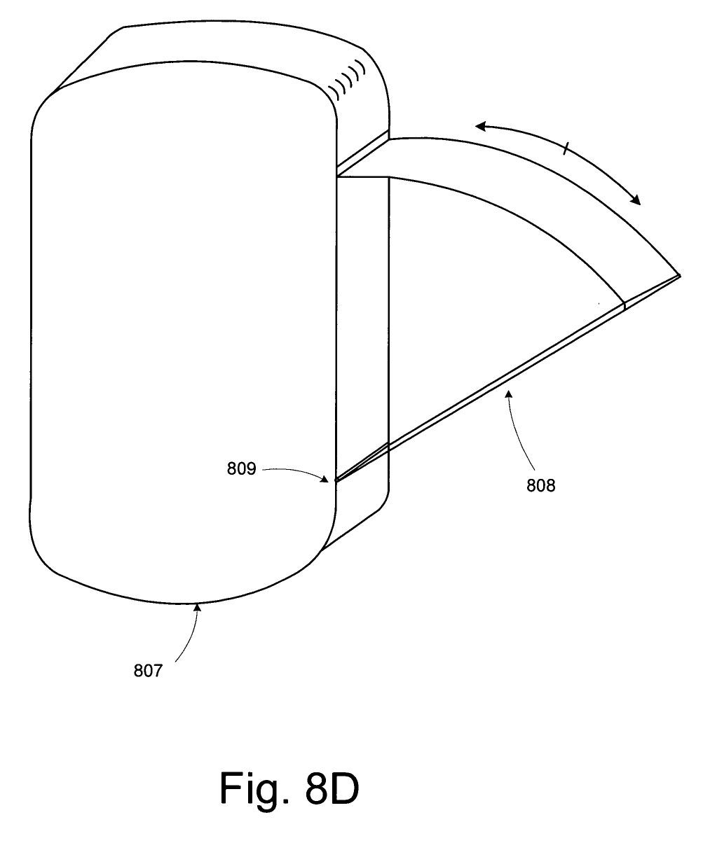

FIG. 8A-8D illustrate numerous opening positions that may be used in accordance with the present invention. FIG. 8A illustrates a sliding door 801 that opens by sliding down into a slot 802. While FIG. 8A illustrates the sliding door 801 as part of the back panel, the sliding door 801 may be positioned in any of the side panels in order to gain access to the storage compartment. FIG. 8B illustrates a door 803 that opens with a pivot 804 in order to gain access into the storage compartment. FIG. 8C illustrates a different opening position, in which the cavity in the storage compartment 805 may be accessed via a drawer 806. While the drawer 806 is depicted as sliding out of the side of the storage compartment, it could similarly slide out of the bottom or top. FIG. 8D illustrates a different opening position, in which a panel of the storage cavity pivots of out of the way. This panel may provide access to the storage cavity, or it may form a drawer 808 that pivots about an axis 809 to open and close into the body of the storage compartment 807. Again, the embodiments illustrated in FIGS. 8A-8D are exemplary only, various other methods of opening the cavity, such as spring-loaded access, magnetic access, etc. are contemplated by the present invention.

Moreover, the storage compartment attached to the mobile device may take on various forms, such as a wallet attached to the mobile device, or even a variety of slots for credit and identification cards or a tubular insert running the length of the mobile device for an item such as an EpiPen™.

With renewed reference to FIG. 7, the particular opening arrangement depicted therein will be discussed. FIG. 7 depicts a mobile device 100 with a storage device 200 integrally attached to the back. In this exemplary embodiment, the storage device 200 opens similar to a book. The storage compartment 200 comprises a casing 220 surrounding a storage cavity 215. The casing 220 comprises a battery cover panel 221 positioned directly against the mobile device 100, and several panels protruding from the battery cover panel 221 away from the mobile device 100. These panels comprise top panel 222, bottom panel 223, left panel 224, and right panel 225. The casing 220 further comprises a back panel 226 which comprises a door 227. The door 227 may form only a portion of the back panel 226, or the entire back panel 226 may be used as the door 227.

With continued reference to FIG. 7, a hinge 230 may be positioned on the left side of the back of the mobile device 100. A latching mechanism 240 may be disposed on the right side of the back of the mobile device 100. The door 227 may be biased into an open position, by way of a spring (coil or otherwise) or by biasing the hinge 230 in a specific direction. When the door 227 is placed into a closed position, the latching mechanism 240 may engage the door 227 with the right panel 225. Alternatively, the latching mechanism 240 may engage the door 227 with the back panel 226, the right panel 225, or the battery cover panel 221.

The exemplary arrangement depicted in FIG. 7 enables a mobile device user holding the mobile device to rotate the device in his or her hand so that the mobile device has its screen towards the user's palm, and the user may open the storage compartment using his or her thumb to release the latching mechanism 240 and open the door 227, in order to gain access to the storage cavity 215.

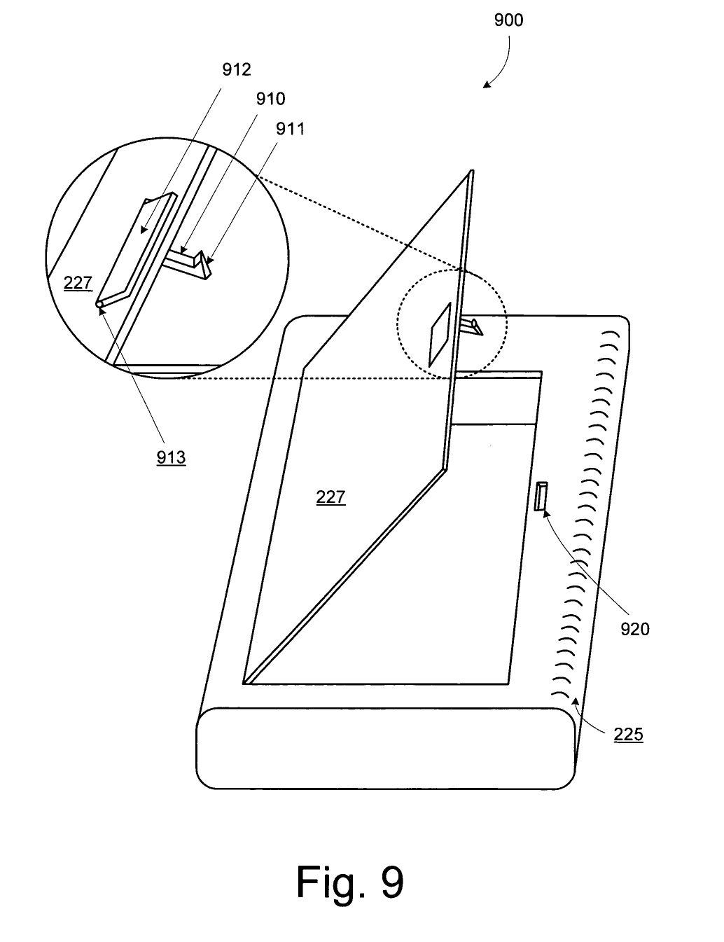

FIG. 9 illustrates an exemplary latching mechanism 900 in accordance with some embodiments of the present invention. Please note that the specific latching mechanism described with reference to FIG. 9 is exemplary only, and should not be used to limit the understanding or construction of the claims. Rather, any latching mechanism (e.g., magnetic, spring-biased, mechanical latch, interference, electromagnetic, etc.) may be utilized in accordance with the present invention.

With continued reference to FIG. 9, the latching mechanism 900 may comprise a hook 910 attached to the door 227, and a receiving slot 920 disposed in the right panel 225. The hook 910 may include a barb 911. The hook 910 may be connected to a button 912. The button 912 may be attached to the door 227 on a pivot or hinge 913. The pivot or hinge 913 may be spring-loaded, or may be manufactured to bias the hook 910 towards the barb 911.

When inserted into the receiving slot 920, the hook 910 may snap over opening of the receiving slot 920, with the barb 911 positioned up against the right panel 225 so that the door 227 may be prevented from opening. In order to open the door, a force is exerted on the button 912, which, due to the pivot or hinge 913 moves the hook 910 in a semi-radial direction away from the barb 911. In other words, because of the pivot or hinge 913, a force on the button 912 causes the hook 910 to move in a direction that has both an X and a Y component. This causes the barb 911 to pull away from the right panel 225 and the opening bias of the door 227 may cause the hook 910 to withdraw from the receiving slot 920.

Note that the door 227 may include one or more latching mechanisms, which may be opened using a single button or using numerous buttons. Moreover, the latching mechanism described with reference to FIG. 9 is exemplary only. Various other mechanisms may be used to latch the door, such as a magnetic force, hook-and-loop devices, a movable piece (such as a dead-bolt) or a rotatable member that engages the door 227 with the casing.

It will be apparent to those skilled in the art that various modifications and variations can be made in the method, manufacture, configuration, and/or use of the present invention without departing from the scope or spirit of the invention. For example, rather than a door providing access to the storage compartment, a drawer could slide out, or an entire panel may be removed or moved out of the way. Similarly, numerous opening arrangements and latching mechanisms may be utilized. It is understood that various components may be omitted from the storage device (e.g., the latching mechanism, one or more side panels, etc.) without deviating from the scope or spirit of the invention.

What I claim is:

1. A storage device integrally attached to a mobile device, the storage device comprising:
a battery cover panel attached to a back surface of the mobile device;
a back panel, the back panel comprising a door that enables access to a storage cavity; and
a plurality of side panels, each protruding from the battery cover panel to the back panel;
wherein the storage cavity is formed by the panels.

2. The storage device of claim 1, wherein the mobile device comprises battery cover attachment mechanisms for a typical battery cover, and wherein the battery cover panel of the storage device attaches to the back surface of the mobile device using the battery cover attachment mechanisms.

3. The storage device of claim 1, wherein the door is connected to the back panel through a hinge, and wherein the door is biased into an open position.

4. The storage device of claim 3, wherein the door comprises a latching mechanism that maintains the door in a closed position.

5. The storage device of claim 4, wherein the latching mechanism engages the door with at least one of the plurality of side panels in order to keep the door in a closed position.

6. The storage device of claim 4, wherein the latching mechanism comprises a door release mechanism for releasing the door from engagement with the at least one of the plurality of side panels.

7. The storage device of claim 4, wherein the latching mechanism comprises a button attached to the latching mechanism, such that depression of the button releases the latching mechanism from its engagement with the at least one of the plurality of side panels.

8. The storage device of claim 1, wherein the storage device further comprises a storage device release mechanism, for disengaging the attachment between the storage device and the mobile device.

9. A storage device for a mobile device, the mobile device comprising a telecommunication unit inside a casing, the storage device comprising:
a rear panel attached to the mobile device;
a back panel; and
a plurality of side panels, each protruding from the battery cover panel to the back panel;
wherein the storage cavity is formed by the panels.

10. The storage device of claim 9, wherein the storage device is integral to the casing of the mobile device.

11. The storage device of claim 9, wherein the storage device is integral to a portion of the casing of the mobile device.

12. The storage device of claim 10, wherein the rear panel of the storage device replaces a portion of the casing of the mobile device.

13. The storage device of claim 9, further comprising a door for accessing the storage cavity.

14. The storage device of claim 13, wherein the door is disposed in the back panel of the storage device.

15. A storage device integrally attached to a mobile device, the mobile device comprising battery cover attachment mechanisms for a typical battery cover, the storage device comprising:
a battery cover panel attached to a back surface of the mobile device using the battery cover attachment mechanisms;
a back panel, the back panel comprising a door that enables access to a storage cavity, the door attached to the back panel through a hinge, the door biased into an open position and comprising a latching mechanism that engages the door with at least one of a plurality of side panels in order to keep the door in a closed position, and wherein the latching mechanism comprises a door release mechanism for releasing the latch engaging the door with the at least one of the plurality of side panels; and
the plurality of side panels, each protruding from the battery cover panel to the back panel;
wherein the storage cavity is formed by the panels.
